(19) United States
(12) Patent Application Publication
(10) Pub. No.: US 2018/0197156 A1
(43) Pub. Date: Jul. 12, 2018

(54) DISTRIBUTED MICRO TRANSACTIONS FOR SOFTWARE DEFINED NETWORKING FLOWS

(71) Applicants: William Eugene Beesley, Murphy, TX (US); Rod Naphan, McKinney, TX (US)

(72) Inventors: William Eugene Beesley, Murphy, TX (US); Rod Naphan, McKinney, TX (US)

(21) Appl. No.: 15/404,924

(22) Filed: Jan. 12, 2017

(51) Int. Cl. G06Q 20/10; H04L 12/911; H04L 12/715; H04L 12/24; H04L 12/14; G06Q 40/02

(52) U.S. Cl. CPC G06Q 20/102; H04L 47/781; G06Q 40/02; H04L 41/12; H04L 12/1485; H04L 45/64

(57) ABSTRACT

Methods and systems for software defined networking data flows includes receiving a request for content from a source, determining the amount of defined network resources required to support the request, comparing the required amount of defined network resources with an amount of network resources provisioned for the source, determining that the required amount of defined network resources exceeds the amount of network resources provisioned for the source, sending a flow request to a software defined networking controller for the request for content from the source, receiving compensation using a payment recording system in response to the flow request, and enabling a data flow associated with the request for content based on receiving compensation. The compensation may be received without a prior relationship with the source of the request for content being established.

### BACKGROUND

### Field of the Disclosure

The present disclosure relates to communications systems and more specifically to distributed micro transactions for software defined networking flows.

### Description of the Related Art

As more applications are provided as networked services (referred to as “cloud applications”) from data center infrastructure (referred to as “the cloud”), the cloud applications are executed on shared physical infrastructure and may be viewed as “tenants” in a multi-tenant cloud. For example, the cloud may represent distributed datacenter infrastructure that includes computing resources and intra-datacenter networks inside each datacenter, along with inter-datacenter optical networks connecting geographically dispersed datacenters. Virtualization of computing resources has emerged as a key technology for the cloud and may enable multiple tenants to efficiently share both computing and network resources.

Along with virtualization, software-based control of network services and functions has also become widespread using software controllers for implementing various network functionality. For example, software-defined networking (SDN) represents an important step towards network virtualization and abstraction and may allow for a logical network entity to be instantiated automatically using software instructions, rather than manually from user input. Due to complexities between software-based network control technologies and actual network provider operations, customization involved with each software controller may add complexity, cost, and delays for rolling out network services.

### SUMMARY

In one aspect, a first computer-implemented method for software defined networking data flows is disclosed. The first method may include receiving a request for content from a source. The amount of defined network resources required to support the request may be determined. The required amount of defined network resources may be compared with an amount of network resources provisioned for the source. The first method may include determining that the required amount of defined network resources exceeds the amount of network resources provisioned for the source. A flow request may be sent to a software defined networking controller. The flow request may be for the request for content from the source. The first method may include receiving compensation using a payment recording system. The receipt of compensation may be in response to the flow request. Compensation may be received without a prior relationship with the source of the request for content being established. The first method may include enabling a data flow associated with the request for content based on receiving compensation.

In another aspect, a system for software defined networking data flows is disclosed. The system may include a software defined networking controller, a payment recording system, and a network operator. The network operator may include logic to receive a request for content from a source. The amount of defined network resources required to support the request may be determined. The required amount of defined network resources may be compared with an amount of network resources provisioned for the source. The network operator may determine that the required amount of defined network resources exceeds the amount of network resources provisioned for the source. A flow request may be sent to the software defined networking controller. The flow request may be for the request for content from the source. The network operator may receive compensation via a payment recording system. The receipt of compensation may be in response to the flow request. Compensation may be received without a prior relationship with the source of the request for content being established. The network operator may enable a data flow associated with the request for content based on receiving compensation. The software defined networking controller may receive the flow request sent from the network operator and may enable the payment recording system to record compensation to be sent to the network operator. The payment recording system may receive payment information from the source of the request for content, verify the payment information, and send at least a portion of the verified payment information to the network operator as the compensation.

Additional disclosed aspects for software defined networking data flows include a system comprising a processor configured to access non-transitory computer readable memory media, an article of manufacture comprising at least one non-transitory computer readable memory medium, which may store processor-executable instructions, and a content provider for software defined networking data flows, as described herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of selected elements of an embodiment of a network, in accordance with embodiments of the present disclosure;

FIG. 2 is a block diagram of selected elements of an embodiment of a software-defined networking (SDN) controller;

FIG. 3 is a block diagram of selected elements of a network for connecting content providers with end users, in accordance with embodiments of the present disclosure;

FIG. 4 is a block diagram of selected elements of a network with distributed micro transactions for software defined networking, in accordance with embodiments of the present disclosure;

FIG. 5 is a flow chart of selected elements of a method for software defined networking for an end user with distributed micro transactions, in accordance with embodiments of the present disclosure;

FIG. 6 is a flow chart of selected elements of a method for software defined networking for a network operator with distributed micro transactions, in accordance with embodiments of the present disclosure; and

FIG. 7 is a flow chart of selected elements of a method for software defined networking for a content provider with distributed micro transactions, in accordance with embodiments of the present disclosure.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

As noted, software-based control of network services using software controllers for implementing various network functionalities may still involve a significant degree of customization. For example, each software defined networking controller may rely upon specific customization to handle service definitions for various standards, such as multiprotocol label switching (MPLS), virtual local area networks (VLAN), and network virtualization using generic routing encapsulation (NVGRE), among others. Examples of software control systems that implement software-based controllers or software controllers, include software-defined networking (SDN) and network function virtualization (NFV) managers. Examples of commercial SDN software controllers include 6WINDGate (6WIND USA, Inc.), Arista EOS (Arista Networks, Inc.), Brocade Vyatta (Brocade Communication Systems, Inc.), Cisco APIC (Cisco Systems, Inc.), and Juniper NorthStar (Juniper Networks, Inc.), among others. The customization of such software controllers with control logic for use by a network operator to fulfill service requirements and support existing network technologies may involve weeks or months of hard-coded software development, even for the most advanced or sophisticated software controllers.

Software control systems may enable the flexibility to implement solutions that may not have been possible without virtualization. This flexibility, however, may often result in less efficiency in virtualized solutions than non-virtualized or hardware counterparts. As a result, software control systems may not employ the same solutions or approaches as non-virtualized or hardware. Rather, software control systems may be optimized for certain functions, such as computing or storing information.

As demand for data increases, particularly with the rise in demand of video, video-conferencing, and cloud computing, the size of data flows and associated network bandwidth may also increase. Content providers may desire to secure a sufficient network flow to support end user demand. Network operators who provide transmission and end user service may desire to be compensated for securing a sufficient network for large data flows. End users or content providers may be unaware of one or more network operators supporting the content provider. Moreover, end users or content providers may not have an established relationship with the network operators in order to provide compensation for securing sufficient network resources.

As will be described in further detail, methods and systems are disclosed for using distributed micro transactions to monetize software defined networking flows. In this manner, an end user or content provider may provide compensation to a network operator without establishing a prior relationship with the network operator in order to secure sufficient network resources for a software defined network data flow.

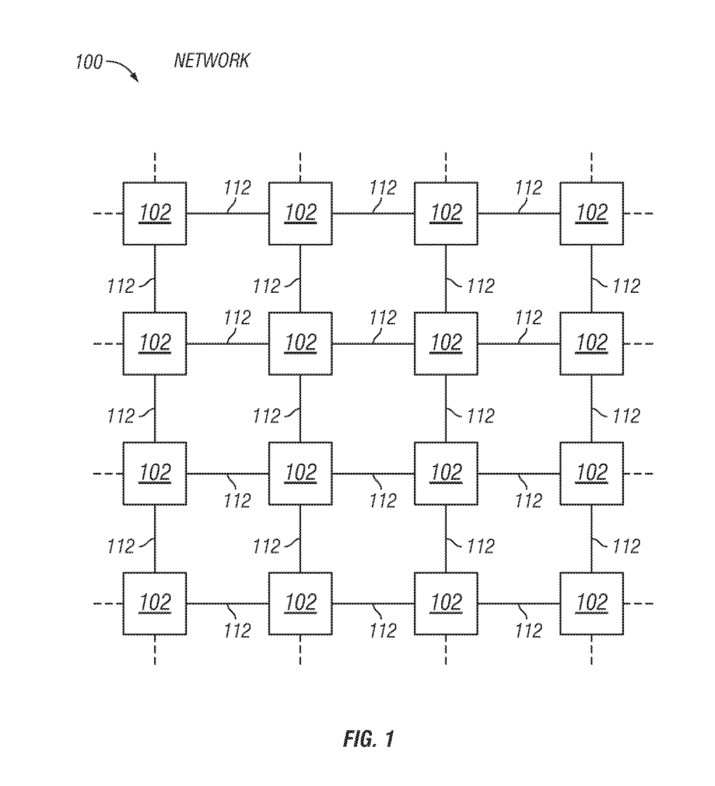

Turning now to the drawings, FIG. 1 is a block diagram showing selected elements of an embodiment of network 100. In certain embodiments, network 100 may be an Ethernet network. Network 100 may include one or more transmission media 112 operable to transport one or more signals communicated by components of network 100. The components of network 100, coupled together by transmission media 112, may include a plurality of network elements 102. In the illustrated network 100, each network element 102 is coupled to four other nodes. However, any suitable configuration of any suitable number of network elements 102 may create network 100. Although network 100 is shown as a mesh network, network 100 may also be configured as a ring network, a point-to-point network, or any other suitable network or combination of networks. Network 100 may be used in a short-haul metropolitan network, a long-haul inter-city network, or any other suitable network or combination of networks.

Each transmission medium 112 may include any system, device, or apparatus configured to communicatively couple network devices 102 to each other and communicate information between corresponding network devices 102. For example, a transmission medium 112 may include an optical fiber, an Ethernet cable, a T1 cable, a WiFi signal, a Bluetooth signal, and/or other suitable medium.

Network 100 may communicate information or “traffic” over transmission media 112. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may transmitted deterministically (also referred to as ‘real-time’) and/or stochastically. In particular embodiments, traffic may be transmitted via a suitable communications protocol, including, without limitation, the Internet Protocol (IP). Additionally, the traffic transmitted via network 100 may be structured in any appropriate manner including, but not limited to, being structured in frames, packets, or an unstructured bit stream. The term packet may also refer to traffic transmitted via network 100.

Each network element 102 in network 100 may comprise any suitable system operable to transmit and receive traffic and may provide a network service. In the illustrated embodiment, each network element 102 may be operable to transmit traffic directly to one or more other network elements 102 and receive traffic directly from the one or more other network elements 102.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

In operation, network 100 may be controlled using software defined networking (SDN) controllers, as described previously. Specifically, devices in network 100 may be configured and programmed in network 100 using various network protocols by SDN controllers. For example, SDN controllers may interface with network devices using one or more of a variety of network protocols, including but not limited to, OpenFlow, TL1, NETCONF, RESTCONF, command line interface (CLI), Open vSwitch Database Management Protocol (OVSDB), and simple network management protocol (SNMP). The SDN controllers may support enabling data flows based on distributed micro transactions, as disclosed herein.

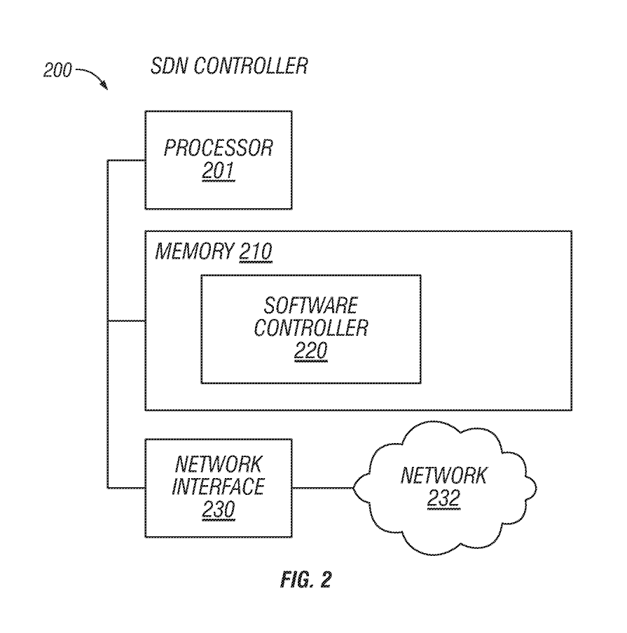

Referring now to FIG. 2, a block diagram of selected elements of an embodiment of SDN controller 200 is illustrated. SDN controller in FIG. 2 may be implemented in network 100, such as a network element 102. SDN controller 200 may support using distributed micro transactions to monetize software defined networking flows.

In FIG. 2, SDN controller 200 is represented as a computer system including physical and location components, as described herein, and may accordingly include processor 201, memory 210, and network interface 230. Network interface 230 may connect processor 201 and/or memory 210 to network 232. Using network interface 230, SDN controller 200 may control one or more elements in network 232 with processor 201 and memory 210. Processor 201 may represent one or more individual processing units and may execute program instructions, interpret data, process data stored by memory 210 or SDN controller 200. It is noted that SDN controller 200 may be implemented in different embodiments. For example, in some embodiments, SDN controller 200 may be implemented using a network node or a network element. In particular embodiments, memory 210 may store executable instructions in the form of a software controller 220 executing on processor 201. Memory 210 may be communicatively coupled to processor 201 and may comprise a system, device, or apparatus suitable to retain program instructions or data for a period of time (e.g., computer-readable media). Memory 210 may include various types components and devices, such as random access memory (RAM), electrically erasable programmable read-only memory (EEPROM), a PCMCIA card, flash memory, solid state disks, hard disk drives, magnetic tape libraries, optical disk drives, magneto-optical disk drives, compact disk drives, compact disk arrays, disk array controllers, or any suitable selection or array of volatile or non-volatile memory. Non-volatile memory refers to a memory that retains data after power is turned off. It is noted that memory 210 may include different numbers of physical storage devices, in various embodiments. As shown in FIG. 2, memory 210 may include software controller 220, among other applications or programs available for execution.

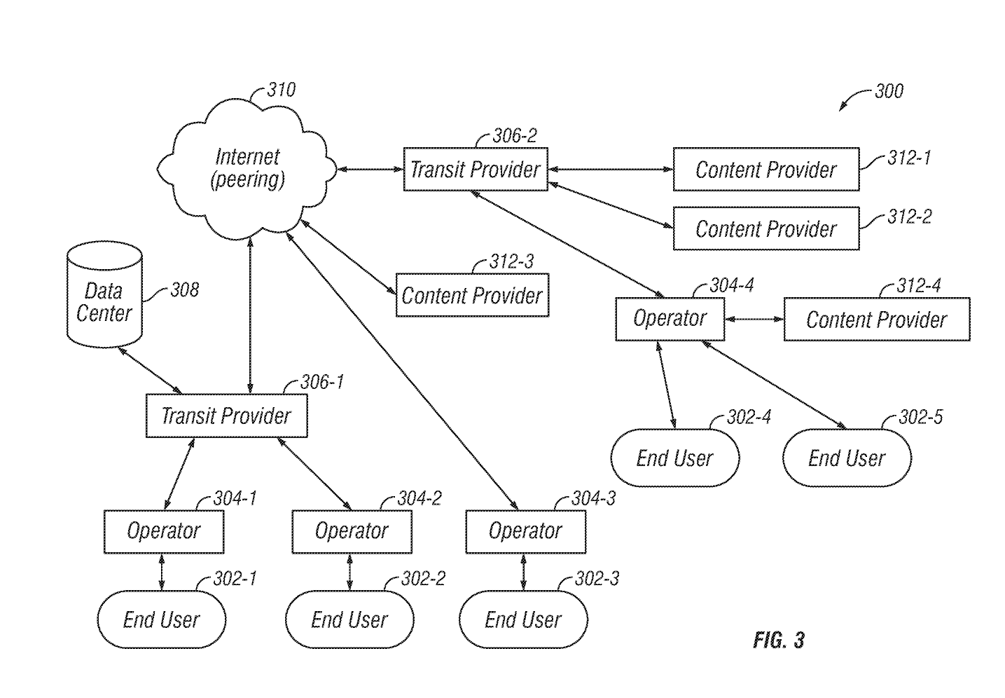

Referring now to FIG. 3, a block diagram of selected elements of a network 300 for connecting content providers with end users is shown in accordance with some embodiments of the present disclosure. An embodiment of a network 300 for connecting content providers with end users in networks, such as, for example, in transport network 100 (see FIG. 1), is illustrated.

As disclosed herein, methods and systems for connecting content providers with end users may include one or more end users 302 and one more content providers 312. End users 302 may desire to consume the content created or distributed by content providers 312. In some embodiments, a content provider 312 may operate as a network operator (304 and 306). In some other embodiments, a network operator (304 or 306) may operate as a content provider 312. The content may include information that represents a large data flow, information that requires minimal or predictable network latency, or information that may be sensitive or private. The content provider may serve the content on a network from another source. The end users 302 may be connected to operators 304. Operators 304 may be connected to transit providers 306, content providers 312, or the Internet 310. For example, end user 302-1 may be connected to operator 304-1, which may be connected to transit provider 306-1. As another example, end user 302-5 may be connected to operator 304-4, which may be connected to content provider 312-4. As a further example, end user 302-3 may be connected to operator 304-3, which may be connected to the Internet 310. Internet 310 may be an Internet peering connection to reduce or eliminate connection costs.

Transit providers 306 may be connected between an operator 304 and the Internet 310, between an operator 304 and a data center 308, or between a content provider 312 and the Internet 310. For example, operator 304-2, which provides a connection to end user 302-2, may be connected to transit provider 306-1, which may be connected to the Internet 310 and data center 308. This topology may enable end user 302-2 to access the Internet 310 or data center 308. As another example, content provider 312-2 may be connected to transit provider 306-2, which may be connected to the Internet 310.

Content providers 312 may be connected to transit providers 306, operators 304, or the Internet 310. For example, content provider 312-1 may be connected to transit provider 306-2. As another example, content provider 312-4 may be connected to operator 304-4. As a further example, content provider 312-3 may be connected to Internet 310 in a direct manner without the use of an intermediary, such as a transit provider 306 or operator 304. In a network topology with hardware defined networking, an end user 302 may have an existing relationship with a content provider 312 in order to compensate the content provider for providing a sufficient network path for the content. Similarly, end user 302 may have an existing relationship with operators 304 and transit providers 306 in order to compensate the operators and transit providers for providing a sufficient network path for the content. While some content providers 312 or operators 304 may reside at layer 3 or may connect with a direct path to a peer network, the content provider 312 may not be able to selectively enable such a connection, which may be more expensive for the content provider, based on the receipt of compensation from the customer. Thus, the content provider 312 and network operators (304 and 306) may not be able to monetize specific network data flows.

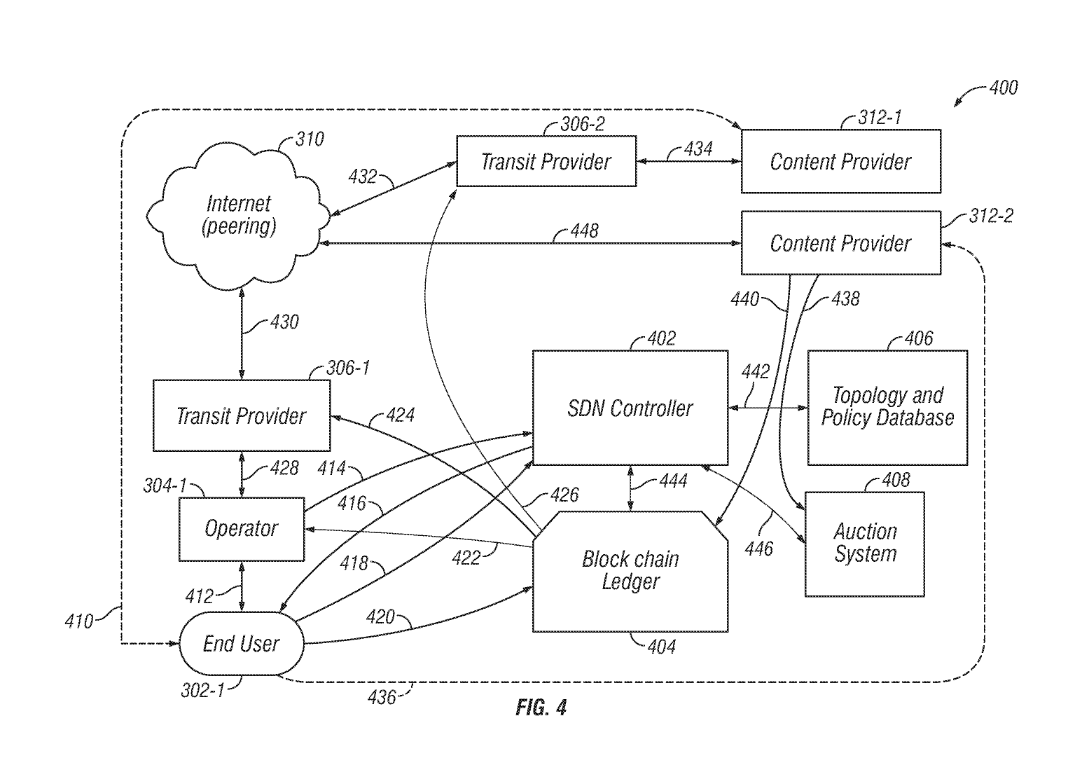

Referring now to FIG. 4, a block diagram of selected elements of a network with distributed micro transactions for software defined networking is shown in accordance with the present disclosure. An embodiment of a network 400 for software defined networking in networks, such as, for example, in transport network 100 (see FIG. 1), is illustrated.

Network 400 may include end users, such as end user 302-1, and content providers, such as content providers 312-1 and 312-2. End-user 302-1 may desire to establish a connection with content provider 312-1. From the perspective of end-user 302-1, the path to the content provider may be direct via connection 410. However, the actual path to the content provider may involve one or more operators 304 or transit providers 306. To establish a connection with content provider 312-1, end user 302-1 may send a request 412 to operator 304-1. End user 302-1 may have an existing relationship with operator 304-1 for operator 304-1 to provide end user 302-1 with a network connection. Operator 304-1 may determine that an existing flow between end user 302-1 and content provider 312-1 has not been established, or that the established flow is insufficient for the content desired by end user 302-1. If the existing flow is not established or insufficient, operator 304-1 may send a flow request via 414 to software defined networking (SDN) controller 402. SDN controller 402 may access via 442 a topology and policy database 406 to retrieve a topology and a policy associated with the flow request. The flow request may specify the needs of the end user or content provider and an identifier for the end user or content provider.

The topology may be the output of a multi-layer path computation engine and topology manager, which collectively maintain the link state and awareness of the cost for a path in the network topology. The topology may represent the output of a path computation, which may determine the optimal route through the network. In some embodiments, the application executed by the end user 302-1 may specify at least a portion of the policy. End user 302-1, or application executed by end user 302-1 may transmit the policy to the operator 304-1 or SDN controller 402. For example, the policy may define the cost for a particular data flow, or for a particular application using an existing data flow. The policy may indicate that end user 302-1 may need to pay a predefined amount for the data flow. The data flow may define the topology that will satisfy the desire of end user 302-1 to receive content from content provider 312-1. The network value may be based on a number of factors including but not limited to, the latency of the network, the bandwidth of the network, the size of the data flow relative to competitors, the ability for a data flow to avoid peer risk groups, or the ability for the data flow to be protected from inspection.

SDN controller 402 may receive the flow request from operator 304-1 via 414 and may send an offer to end user 302-1 via 416. The offer may contain the amount to be paid to one or more operators 304 or one or more transit providers 306. The end user 302-1 may evaluate the offer, or an application executed by end user 302-1 may evaluate the offer against a policy. The policy may include rules regarding what operators 304 or transit providers 306 are acceptable, or how much of an offer to accept. If the end user 302-1, or an application executed by end user 302-1 determines that the offer is acceptable, end user 302-1 may send an acceptance via 418 back to SDN controller 402 and may send payment to a payment processing service.

The payment recording system may receive payment information from end users 302, and may send payment information to one or more operators 304 or one or more transit providers 306. In one embodiment, the payment recording system may be a block chain transaction system with blockchain ledger 404 as illustrated. Blockchain ledger 404 may utilize a public listing of transactions. Each network element in a network may include a blockchain ledger similar to blockchain ledger 404 to record transactions. Each network element may be able to see transactions or payment information that are recorded by reading blockchain ledger 404. Accordingly, once the payment information or transaction is recorded in blockchain ledger 404, a payment may be sent to the recipient, which may be a network element with access to blockchain ledger 404, without any additional processing by blockchain ledger 404.

Blockchain ledger 404 may use digital currency to avoid currency conversion. A financial intermediary may provide currency conversion services to and from the digital currency used by blockchain ledger 404. Content providers 312 or end users 302 may use a digital wallet provided by the financial intermediary to buy digital currency or data flow capacity to sell to other content providers or end users. Financial intermediaries may exchange network resources for fiat currency to establish the rate of exchange for the digital currency. Accordingly, the network value of the digital currency may be established and maintained by the scarcity of the supply of digital currency relative to the demand of the digital currency.

Blockchain ledger 404 may be associated with a distributed database with transaction records. The number of transaction records or blocks, in the database or chain may increase over time. In some embodiments, the maximum number of records may be limited to the amount of address space for storing the records. The address space may increase over time to support more records and larger addresses. Each block can contain a valid transaction, or a plurality of valid transactions, a timestamp, and a link to a previous block in the chain or database. The link may be in the form of a hash that may represent the previous block. Blockchain ledger 404 may serve as a public record of all transactions in the payment processing service. Each network element in a network, such as network 100, may share new transactions and verify transactions shared by all network elements in the network. Transactions may be verified using any suitable technique, such as using a digital signature of the sender, and may be encrypted using any suitable technique, such as using a digital signature of the recipient(s). Verification may include confirming that the amount to be distributed does not exceed the amount provided. For example, an end user cannot provide $2 to complete the payment of $3. Senders may vary their signature or identity, which may provide privacy protection for a public blockchain ledger. A transaction may be verified by other network elements.

The payment received from an end user 302 by the payment recording system via 420 may specify one or more recipients. For example, end user 302-1 may provide $4 for payment with $2 for operator 304-1 and $1 each for transit providers 306-1 and 306-2. Although dollars are used in this example, the currency may be in any form. The payment recording system may provide the payment to the one or more recipient(s) by recording the transaction. In the example illustrated, blockchain ledger 404 may provide payment to operator 304-1 via 422, transit provider 306-1 via 424, and transit provider 306-2 via 426.

Once the operators or transit providers have received payment or the payment has been recorded by the payment recording system, SDN controller 402 may configure the network data flow for end user 302-1. In some embodiments, blockchain ledger 404 or SDN controller 402 communicatively coupled to blockchain ledger 404 via 444 may enforce a policy that may require a minimum number of transactions linked to the payment by end user 302-1 before the network data flow is configured. Once the network data flow is configured, content provider 312-1 may send content via 434 to transit provider 306-2. Transit provider 306-2 may send the content via 432 to Internet peering 310, which may route the content to transit provider 306-1. Transit provider 306-1 may send the content via 428 to operator 304-1, which was previously connected to end user 302-1 via 412. Content provider 312-1 may then provide content in a sufficient manner to end user 302-1 without the end user 302-1 having a prior relationship with transit providers 306-1 or 306-2, such as an account with transit provider 306-1 or 306-2.

As another example, content provider 312-2 may desire to establish a data flow in a sufficient manner with end user 302-1. From the perspective of end user 302-1, the connection to content provider 312-2 may appear to be connection 436. The actual connection between end user 302-1 and content provider 312-2, however, may involve one or more operators 304 or one or more transit providers 306. Content provider 312-2 may have an existing connection with the Internet 310 and may not have an existing relationship with transit provider 306-1.

Content provider 312-2 may provide a payment to establish a connection via transit provider 306-1 to end user 302-1. The payment may be provided using an auction system 408. In one embodiment, auction system 408 may be distributed over multiple locations or network elements. For example, in a global network each country may have a portion of the auction system and countries may bid on the data flows in another country. In another embodiment, auction system 408 may be within a network element.

Auction system 408 may establish or maintain the network value based on how much participants bid on a defined network resource. Auction system 408 may include blockchain ledger 404 (not shown) and may be operated separate from SDN controller 402 or topology and policy database 406. Auction system 408 may communicate via 446 with SDN controller 402 to determine the available network resources for auction and/or to notify SDN controller 402 of an awarded network resource. Content providers 312 may provide offers or bids to auction system 408. The highest offer or bid for a defined network resource may be awarded the defined network resource. The defined network resource may be any suitable software defined networking configuration, including but not limited to the configuration for a data flow or a time slice for an existing configuration. In the illustrated example, content provider 312-2 may provide an offer via 438 to auction system 408 for the defined network resource that is desired. A content provider 312-2 may decide which defined network resource to bid on based upon the resources provided or the estimated costs of the resource.

If content provider 312-2 is awarded the defined network configuration, content provider 312-2 may provide payment information to the payment recording system, which may distribute the payment to the necessary network elements to enable the defined network configuration. In the illustrated example, content provider 312-2 may provide payment via 440 to blockchain ledger 404, which may distribute payment to transit provider 306-1 via 424. Once transit provider 306-1 has received payment, content provider 312-1 may provide content to end user 302-1 via 430 to transit provider 306-1, which may provide the content via 428 to operator 304-1. Operator 304-1 may be connected to end user 302-1 via 412. Content provider 312-2 may then provide content in a sufficient manner to end user 302-1 without the content provider 312-2 having a prior relationship with transit provider 306-1. Moreover, content provider 312-2 may provide content in a sufficient manner to end user 302-1 based on a payment transaction that may be processed in an automated manner, which may enable several hundreds to millions of transactions per minute, in which each transaction enables a software defined networking flow.

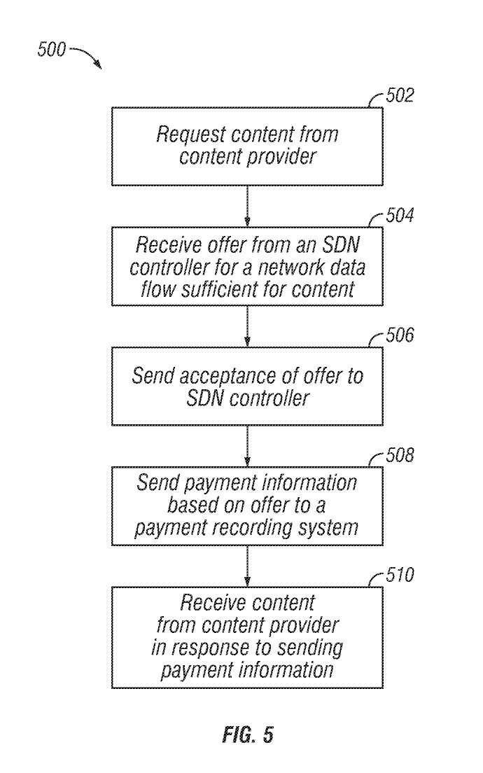

Referring now to FIG. 5, a flow chart of selected elements of a method 500 for software define networking with distributed micro transactions for an end user is shown in accordance with some embodiments of the present disclosure. Method 500 may be implemented by any of the elements shown in FIGS. 1-4 and 6-7. Method 500 may be initiated by any suitable criteria and may initiate operation at any suitable point. In one embodiment, method 500 may initiate operation at 502. Method 500 may include greater or fewer steps than those illustrated. Moreover, method 500 may execute its steps in an order that is different than those illustrated below. Method 500 may terminate at any suitable point. Moreover, method 500 may repeat operation at any suitable point. Portions of method 500 may be performed in parallel and repeat with respect to other portions of method 500.

At 502, an end user may request content from a content provider. Although an end user is described, the end user may be a network element associated with an end user. The request may originate from an application provided by the content provider. The request may include information about the source and/or destination of the request. The request may specify the requirements for the content to be received by the end user. For example, the end user may be interested in streaming high resolution video with a high bitrate from a live broadcast. A request to support such a video may include information about the video, or information about what the video may require, such as the bandwidth required to send the video or the latency required for a live broadcast.

At 504, the end user may receive an offer from an software defined networking (SDN) controller. The offer may be associated with the request and may specify the network data flow sufficient for the content. In some embodiments, the request may indicate how much currency is required to be sent to each entity in the network data flow that requires payment.

At 506, the end user may send acceptance of the offer to the SDN controller. While a user may click on a button to agree to the terms of the offer, an application executed by the end user may determine whether to accept the offer in an automated fashion based on whether the terms of the offer satisfy one or more rules established in a policy. Referring to the example from method step 502, the user may have an account established with a content provider for live broadcast streaming of video. An application associated with the content provider may be executed by the end user. The application may include a policy for what network data flows for which the user previously provided acceptance. For example, the policy may specify that the end user may pay for a network data flow that supports higher resolution video and the user may have previously agreed to accept offers for such network data flows. Accordingly, the application may send the acceptance on the behalf of the user.

At 508, the end user may send payment information based on the offer. The payment information may be sent to a payment recording system, such as a blockchain ledger. The payment information may include details about how much currency is provided to each recipient. In at least one embodiment, the payment information may include details to verify the identity of the sender and content of the payment. In some embodiments, an application associated with the request may include or have access to payment information to provide payment if the offered network data flow is within the policy. The blockchain ledger may record the payment information and the SDN controller may configure the data flow. The blockchain ledger with the recorded payment information may be publicly visible to other nodes in the network, which may see the payment information and may validate that the payment was sent and received. At 510, the end user may receive content from the content provider in response to sending the payment information. Method 500 may optionally repeat or terminate.

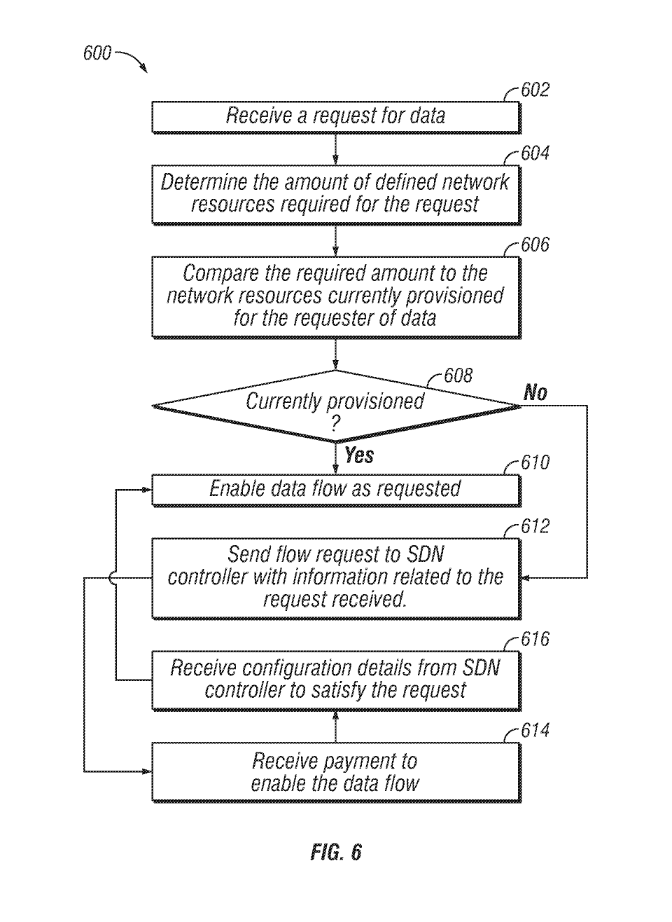

Referring now to FIG. 6, a flow chart of selected elements of a method 600 for software define networking with distributed micro transactions for a network operator is shown in accordance with some embodiments of the present disclosure. Method 600 may be implemented by any of the elements shown in FIGS. 1-5 and 7. Method 600 may be initiated by any suitable criteria and may initiate operation at any suitable point. In one embodiment, method 600 may initiate operation at 602. Method 600 may include greater or fewer steps than those illustrated. Moreover, method 600 may execute its steps in an order that is different than those illustrated below. Method 600 may terminate at any suitable step. Moreover, method 600 may repeat operation at any suitable step. Portions of method 600 may be performed in parallel and repeat with respect to other portions of method 600.

At 602, a network operator, which may be an operator 304 or a transit provider 306, may receive a request for data or content from a source, such as an end user or content provider. The request may include information about the source or requestor, information about the source of the data, and/or information about the data. For example, the request may include the internet protocol (IP) address of the requestor, the IP address of the data source, and/or the amount of bandwidth or latency required by the data to sufficiently flow through the network.

At 604, the network operator may determine the amount of defined network resources required for the request. Defined network resources may include any suitable resource including but not limited to, the bandwidth, latency, priority, safety, or protection required by the data to flow through the network. The bandwidth definition may correspond to the number of bits per second that the network must transmit to support the data flow. The latency definition may correspond to the amount of time required to transmit the data flow through the network. The priority definition may enable the network to prefer the data flow over other data flows through the network. The safety definition may correspond to whether the data flow should avoid certain topologies that are unsafe, such as peer groups. The protection definition may enable the network to prevent intrusion or observation of the data flow through the network. In some embodiments, the defined network resource may be a time slice of the network in which the network is dedicated to the data flow for a defined duration or percentage of a defined duration.

At 606, the network operator may compare the required amount of defined network resources to the network resources currently provisioned for the requestor of the data. The provisioned network resources may correspond to the resources deployed, or the resources that are capable of being deployed, which may be based on an agreement with the network operator. If the network operator does not have a prior relationship with the requestor of the data, there may be no network resources provisioned for the requestor. At 608, it may be determined whether the required amount is currently provisioned. If the required amount is provisioned, method 600 may proceed to 610. Otherwise, method 600 may proceed to 612.

At 612, the network operator may send a flow request to an SDN controller with information related to the request received. The information in the flow request may be sufficient for the SDN controller to determine the optimal topology based on performance and/or cost. For example, the information may include the bandwidth required by the request received by the network operator and the cost restrictions of the network operator or requestor. The flow request may include information about the requestor, which may enable the SDN controller to communicate directly with the requestor to pay for and enable the flow.

At 614, the network operator may receive payment via a payment recording system, such as a blockchain ledger, to enable the data flow associated with the request for data. The payment may be received without a prior relationship being established between the source of the content and the network operator. At 516, the network operator may receive configuration details from the SDN controller to satisfy the request for data. The configuration details may include information about how the network operator should route the data. At 610, the network operator may enable the data flow as requested. In one embodiment, the network operator may verify the payment before enabling the data flow. Method 600 may optionally repeat or terminate.

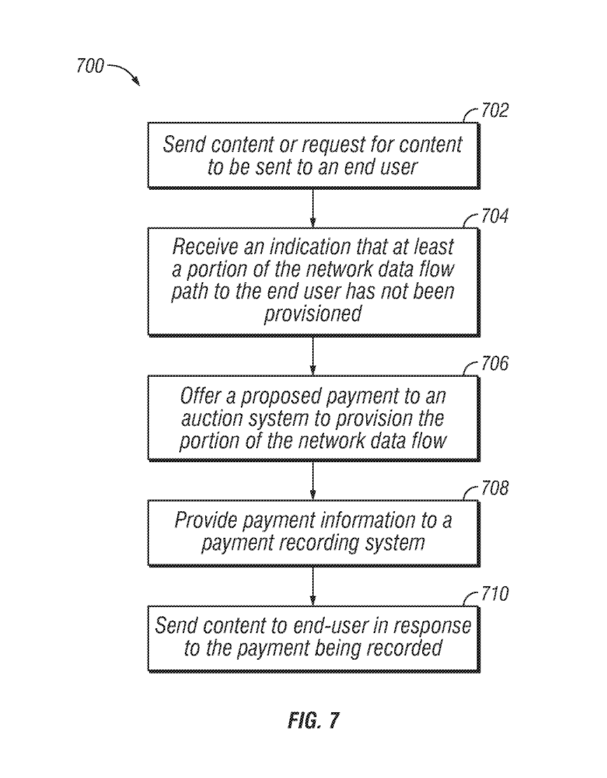

Referring now to FIG. 7, a flow chart of selected elements of a method 700 for software define networking with distributed micro transactions for a content provider is shown in accordance with some embodiments of the present disclosure. Method 700 may be implemented by any of the elements shown in FIGS. 1-6. Method 700 may be initiated by any suitable criteria and may initiate operation at any suitable point. In one embodiment, method 700 may initiate operation at 702. Method 700 may include greater or fewer steps than those illustrated. Moreover, method 700 may execute its steps in an order that is different than those illustrated below. Method 700 may terminate at any suitable step. Moreover, method 700 may repeat operation at any suitable step. Portions of method 700 may be performed in parallel and repeat with respect to other portions of method 700.

At 702, a content provider may send content or a request for content to be sent to an end user. At 704, the content provider may receive an indication that at least a portion of the network data flow path to the end user has not been provisioned. In one embodiment, the indication may be based on receiving no response from the content or request that is sent. In another embodiment, the portion of the network data flow path that has not been provisioned may send the indication to the content provider.

At 706, the content provider may offer a proposed payment to an auction system to provision the portion of the network data flow. In one embodiment, the auction system may have predefined or published pricing, similar to an exchange. In another embodiment, the auction system may award the network resources based on the highest bid or offer. The content provider may receive an indication that the offer has been accepted by the auction system.

At 708, the content provider may provide payment information to a payment recording system. In one embodiment, the auction system includes the payment recording system, in which the content provider may provide the offer and the payment information in parallel. In another embodiment, the auction system may be separate from the payment recording system, in which the content provider receives an indication from the auction system that the offer has been accepted before the content provider provides the payment information to the payment recording system. The payment information may specify the amount in any suitable currency, including digital currency, and may specify the portion of the network that will send and receive the payment.

At 710, after the content provider sends the payment information to the payment recording system, the content provider may send the content to the end-user in response to the payment information being recorded by the payment recording system. The portion of the network data flow path to the end user that had not been provisioned will have received the payment and enabled the content to be sent. In some embodiments, the portion of the network data flow path may have previously received at least a portion of the content for the end-user and may route the portion to the end user in response to the content provider sending payment without the content provider sending the portion again.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A computer-implemented method for software defined networking data flows, the method comprising:
receiving a request for content from a source;
determining an amount of defined network resources required to support the request;
comparing the required amount of defined network resources with an amount of network resources provisioned for the source;
determining that the required amount of defined network resources exceeds the amount of network resources provisioned for the source;
sending a flow request to a software defined networking controller for the request for content from the source;
receiving compensation using a payment recording system in response to the flow request without a prior relationship with the source of the request for content being established; and
enabling a data flow associated with the request for content based on receiving compensation.

2. The method of claim 1, wherein receiving compensation using a payment recording system comprises:
receiving compensation via a transaction verified by a public blockchain ledger of the payment recording system.

3. The method of claim 1, further comprising receiving configuration details from the software defined networking controller for the data flow.

4. The method of claim 1, wherein the source of the request for content is a content provider.

5. The method of claim 1, wherein the required amount of defined network resources comprises a bandwidth requirement corresponding to a defined amount of data per second that is required to support the content.

6. The method of claim 1, wherein the flow request comprises:
information about the source; and
information for the software defined networking controller to determine a topology for the request for content.

7. A system for software defined networking data flows, comprising:
a software defined networking controller;
a payment recording system;
a network operator, the network operator is to:
receive a request for content from a source;
determine an amount of defined network resources required to support the request;
compare the required amount of defined network resources with an amount of network resources provisioned for the source;
determine that the required amount of defined network resources exceeds the amount of network resources provisioned for the source;
send a flow request to the software defined networking controller for the request for content from the source;
receive compensation from the payment recording system without a prior relationship with the source of the request for content; and
enable a data flow associated with the request for content based on the receipt of compensation;
the software defined networking controller is to:
receive the flow request sent from the network operator; and
enable the payment recording system to record compensation to be sent to the network operator; and
the payment recording system is to:
receive payment information from the source of the request for content;
verify at least a portion of the payment information; and
send at least a portion of the verified payment information to the network operator as the compensation.

8. The system of claim 7, wherein the payment recording system comprises a public block chain ledger to verify the payment information.

9. The system of claim 7, wherein the software defined networking controller sends configuration details to the network operator and the network operator configures the data flow based on the configuration details.

10. The system of claim 7, wherein the source of the request for content is a content provider.

11. The system of claim 7, wherein the network operator determines the required amount of defined network resources by determining the amount of bandwidth required, the bandwidth corresponding to a defined amount of data per second that is required to support the content.

12. The system of claim 7, wherein the flow request comprises:
information about the source of the request; and
information for the software defined networking controller to determine a topology for the request for content.

13. The system of claim 7, wherein the network operator provides the compensation to a financial intermediary to convert the compensation to a currency.

14. At least one non-transitory computer readable memory medium, the medium to store processor-executable instructions, the instructions, when executed by a processor, cause the processor to:
receive a request for content from a source;
determine an amount of defined network resources required to support the request;
compare the required amount of defined network resources with an amount of network resources provisioned for the source;
determine that the required amount of defined network resources exceeds the amount of network resources provisioned for the source;
send a flow request to a software defined networking controller for the request for content from the source;
receive compensation via a payment recording system in response to the flow request without a prior relationship with the source of the request for content; and
enable a data flow associated with the request for content based on the receipt of compensation.

15. The medium of claim 14, wherein the instructions to receive compensation via a payment recording system include instructions that, when executed by the processor, cause the processor to:
receive compensation via a transaction verified by a public blockchain ledger of the payment recording system.

16. The medium of claim 14, further comprising instructions that, when executed by the processor, cause the processor to:
receive configuration details from the software defined networking controller for the data flow.

17. The medium of claim 14, wherein the source of the request for content is a content provider.

18. The medium of claim 14, wherein the instructions to determine the required amount of defined network resources include instructions that, when executed by the processor, cause the processor to:
determine the amount of bandwidth required, the bandwidth corresponding to a defined amount of data per second that is required to support the content.

19. The medium of claim 14, wherein the flow request comprises:
information about the source of the request; and
information for the software defined networking controller to determine a topology for the request for content.

20. The medium of claim 14, further comprising instructions that, when executed by the processor, cause the processor to:
provide the compensation to a financial intermediary to convert the compensation to a currency.
